(19) United States
(12) Patent Application Publication
(10) Pub. No.: US 2005/0091972 A1
(43) Pub. Date: May 5, 2005

(54) Electrohydraulic actuator

(76) Inventor: Kenneth K. Redman, Fredonia, WI (US)

Correspondence Address: MCKELLAR IP LAW, PLLC, 784 SOUTH POSEYVILLE ROAD, MIDLAND, MI, 48640, US

(21) Appl. No.: 10/968,748

(22) Filed: Oct. 19, 2004

Related U.S. Application Data
(60) Provisional application No. 60/516,344, filed on Oct. 31, 2003.

(51) Int. Cl. F16D 31/02

(52) U.S. Cl. 60/413

(57) ABSTRACT

An improved electrohydraulic actuator and method of the type that incorporates a piston secured to a member to be controlled and capable of moving in a cylinder under drive from a hydraulic fluid, a pump for pressurizing hydraulic fluid, an electric motor for driving the pump and a hydraulic accumulator for containment of variable volumes of hydraulic fluid. The improvement relates to the hydraulic pump. The pump incorporates a pump piston positioned in and slidably sealed in a first pump cylinder for pressurizing hydraulic fluid in the first pump cylinder, a piston rod extending through and slidably sealed to the pump piston and a second pump cylinder for receiving the piston rod slidably sealed in the second pump cylinder for pressurizing hydraulic fluid in the second pump cylinder. The diameter of the first pump cylinder is greater than the diameter of the second pump cylinder, so that when the hydraulic fluid pressure increases above a set pressure in the first pump cylinder, then the piston rod enters the second pump cylinder to pressurize the hydraulic fluid in the second pump cylinder to a pressure above the set pressure.

### PRIORITY

This application claims priority from U.S. Provisional Application No. 60/516344 filed Oct. 31, 2003.

### BACKGROUND

The instant invention relates to actuators and more specifically, to electrohydraulic actuators.

Electrohydraulic actuators are known, see for example U.S. Pat. No. 6,796,120. Electrohydraulic actuators use an electric motor driven pump integral with the actuator and were an important advance in the art. However, such known electrohydraulic actuators also suffered from a number of shortcomings. For example, the power and speed of the actuator's ram is linearly dependent on the power and speed of the hydraulic pump. It would be an advance in the art if an electrohydraulic actuator were discovered that advanced the actuator's ram at a relatively rapid speed at relatively low power and then automatically converted to a lower speed, higher power advance when the ram meets with increased resistance.

### SUMMARY OF THE INVENTION

The instant invention is an improved electrohydraulic actuator that advances its ram at a relatively rapid speed at relatively low power and then automatically converts to a lower speed, higher power advance when the ram meets with increased resistance. The improved electrohydraulic actuator of the instant invention is useful, for example, for hole punch, hole pierce, lifting, mechanical forming presses, clinching, forming, staking, shearing and embossing ferrous and non-ferrous materials.

More specifically, the instant invention is an improved electrohydraulic actuator, comprising a piston secured to a member to be controlled and capable of moving in a cylinder under drive from a hydraulic fluid, a pump for pressurizing hydraulic fluid, an electric motor for driving the pump and a hydraulic accumulator for containment of variable volumes of hydraulic fluid, wherein the improvement comprises: the pump comprising a pump piston positioned in and slidably sealed in a first pump cylinder for pressurizing hydraulic fluid in the first pump cylinder; a piston rod extending through and slidably sealed to the pump piston; a second pump cylinder for receiving the piston rod slidably sealed in the second pump cylinder for pressurizing hydraulic fluid in the second pump cylinder, the diameter of the first pump cylinder being greater than the diameter of the second pump cylinder, so that when the hydraulic fluid pressure increases above a set pressure in the first pump cylinder, then the piston rod enters the second pump cylinder to pressurize the hydraulic fluid in the second pump cylinder to a pressure above the set pressure.

In another embodiment, the instant invention is an improved method for electrohydraulic actuation, comprising the steps of pressurizing hydraulic fluid with an electric pump, moving a member to be controlled under drive from the pressurized hydraulic fluid, wherein the improvement comprises the step of: intensifying the pressure of the hydraulic fluid when the pressure of the hydraulic fluid increases to a set point.

### BRIEF DESCRIPTION OF THE DRAWINGS

FIG. 1 is an isometric view of an apparatus embodiment of the instant invention;

FIG. 2 is a side view of the apparatus of FIG. 1, part in cross-section and part in full, with its ram in the retracted position;

FIG. 3 is a side view of the apparatus of FIG. 1, part in cross-section and part in full, with its ram in the extended position;

FIG. 4 is a side view, part in cross-section and part in full, of the upper body assembly of the apparatus of FIG. 1;

FIG. 5 is a side view, part in cross-section and part in full, of the mid body assembly of the apparatus of FIG. 1;

FIG. 6 is a side view, part in cross-section and part in full, of the lower body assembly of the apparatus of FIG. 1 with its ram in the extended position;

FIG. 7a is a side view, part in cross-section and part in full, of the lower body assembly of the apparatus of FIG. 1 with its ram in the retracted position;

FIG. 7b is a partial end view of the lower body assembly of the apparatus of FIG. 1;

FIG. 8 is a side view, part in cross-section and part in full, of the lower body assembly of the apparatus of FIG. 1 with its ram in the retracted position; and

FIG. 9 is a side view in cross-section of drive piston assembly of the apparatus of FIG. 1.

### DETAILED DESCRIPTION OF THE INVENTION

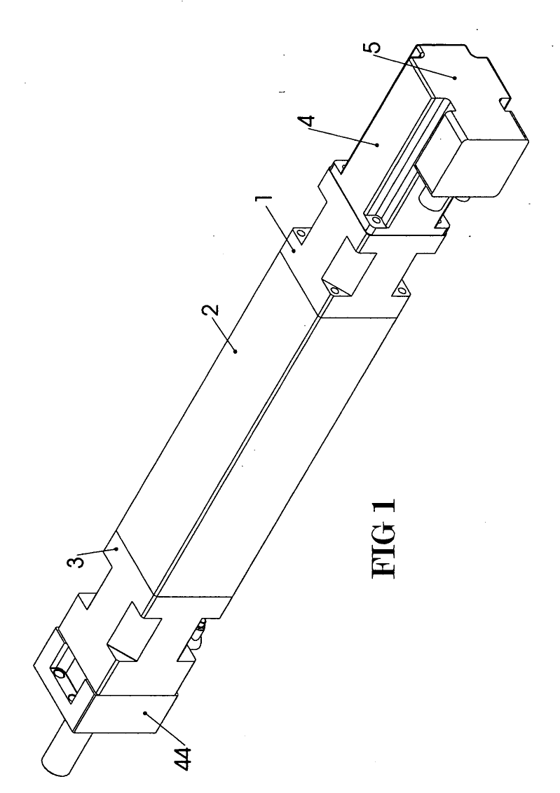

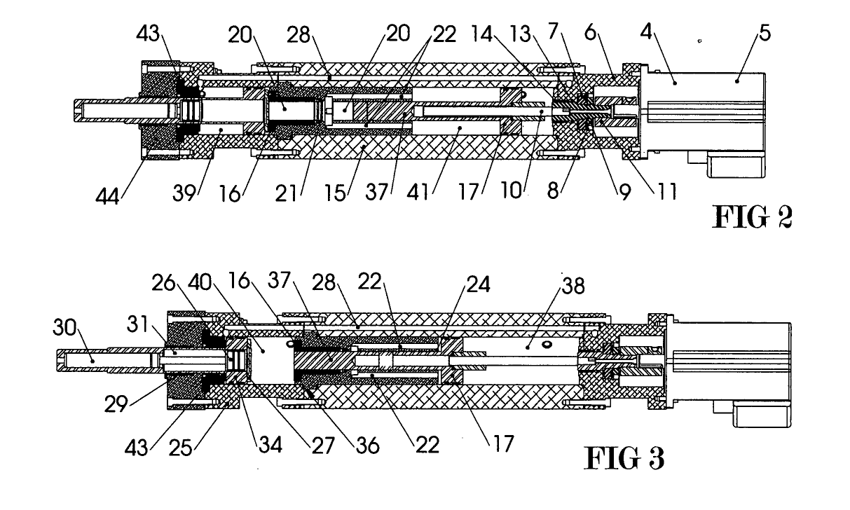

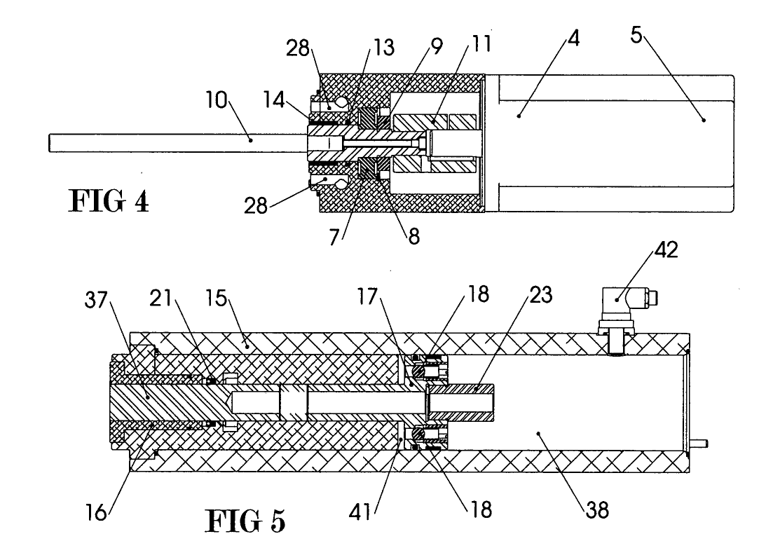

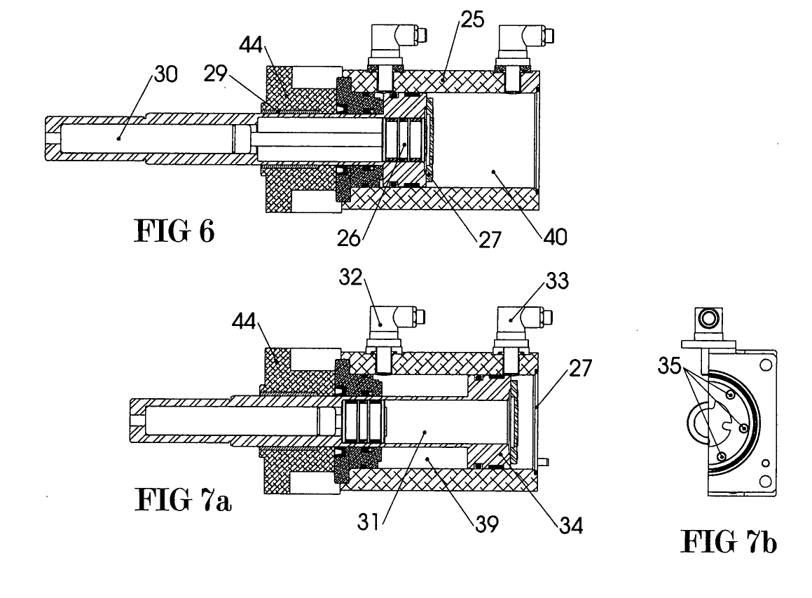

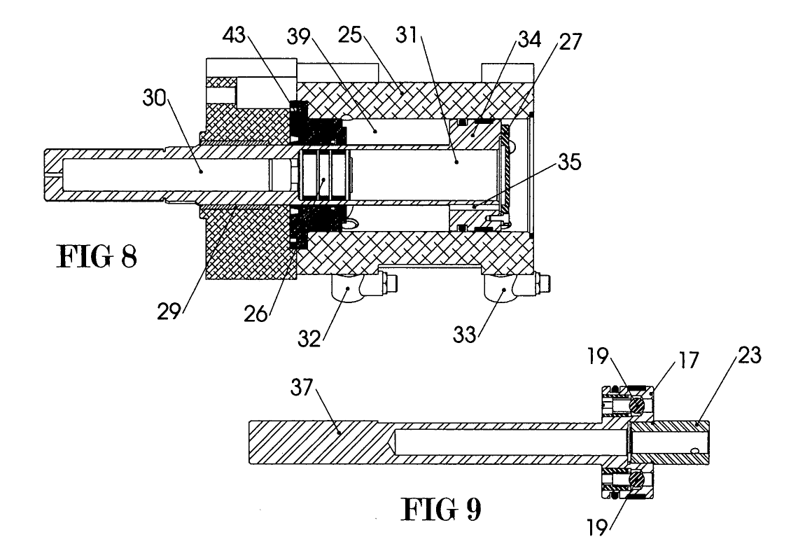

Referring now to FIGS. 1-9: Upper Body Assembly (1) consists of electric servo motor (4), motor resolver (5), upper body (6), radial-thrust bearing (7), retaining ring (8), bearing lock nut (9), ball screw (10), alignment coupler (11), rotary seal (13), and journal bearing (14).

Mid Body Assembly (2) consist of mid body (15), high pressure sleeve (16), drive piston (17), drive piston rod (37), drive piston cap end chamber (38), drive piston rod end chamber (41), advance check valves (18), return check valves (19), high pressure chamber (20), high pressure seal (21), rapid advance ports (22), ball screw nut (23), and anti-rotation key (24), fluid passage (28), home sensor (42).

Lower Body Assembly (3) consists of lower body (25), accumulator piston (26), accumulator piston cover plate (27), rod bushing (29), nitrogen spring (30), accumulator chamber (31), piston advance sensor (32), piston retract sensor (33), ram piston (34), accumulator ports (35), ram piston rod end chamber (39), ram piston cap end chamber (40), ram bushing and seal assembly (43), adapter-bushing mounting plate (44).

Electric servo motor (4) is capable of clockwise and counter-clockwise angular motion, variable torque output and angular position feedback to drive the ball screw (10) coupled to ball screw nut (23). Ball screw nut (23) is attached to drive piston (17). Drive piston (17) extends and retracts within the bore of mid body (15) powered by the servo motor (4). Anti-rotation key (24) restrains drive piston (17) from rotating during extend and retract motions. As drive piston (17) is extended, hydraulic fluid on the rod end chamber of drive piston (17) is forced through the rapid advance ports (22) contained within the high pressure sleeve (16) and continues past the drive piston rod (37) and into the ram piston cap end chamber (40) contained within lower body (25).

Ram piston (34) is rapidly extended forward under low pressure-low force. The ram piston extend rate and distance traveled during low pressure-low force phase is dependant upon the ratio between the drive piston rod end and ram piston cap end areas. In this embodiment, the rapid advance distance traveled by ram piston (34) is equal to the distance traveled by drive piston (17). The drive piston extend rate and travel distance can be modified while in motion to proportionally alter the ram piston extend rate and distance traveled during same period in time. Drive piston (17) continues to extend and transitions into the high pressure-high force phase when the drive piston rod (37) engages the high pressure seal (21) located within the high pressure sleeve (16).

Contact between the drive piston rod (37) and high pressure seal (21) blocks all flow from drive piston rod end chamber (41) to ram piston cap end chamber (40). Fluid trapped between the drive piston rod end chamber (41) and high pressure seal (21) is diverted through check valve (19) to the drive piston cap end chamber (38) allowing drive piston (17) to continue extend motion during the high pressure-high force phase. In this embodiment the drive piston (17) advances 3.3954 inches during the high pressure-high force phase which proportionally translates into a ram piston (34) travel of 0.500 inches.

Ratios between the drive piston diameter, drive piston rod diameter, ram piston diameter and ram piston rod diameter can be altered to achieve different ram piston (34) output forces, rate of travel and distance traveled relative to the drive piston (17). Check valve (19) free flow direction is opposite that of check valve (18). Hydraulic fluid in the ram piston rod end chamber (39) is routed through fluid passage (28) to drive piston cap end chamber (38). Hydraulic fluid stored under low pressure in accumulator chamber (31) and fluid from the ram piston rod end chamber (39) and drive piston rod end chamber (37) combine and are of sufficient volume to fill the developing void on drive piston cap end chamber (37) during extend and completion of stoke.

In this embodiment the accumulator assembly is located inside the ram piston rod. The accumulator can also be mounted external to the actuator to increase fluid discharge capacity and improve serviceability. However, locating the accumulator assembly inside the ram piston rod has the advantages of reducing the outside dimensions of actuator, reduces the number of seals and connections that may result in fluid leakage to the atmosphere. In this embodiment the accumulator assembly consists of an accumulator piston (26), accumulator chamber (31) and pre-charged nitrogen spring (30) which outputs a nearly constant force against the accumulator piston during full range of stroke.

The nitrogen spring output force can be adjusted to increase or decrease the fluid pressure and rate of discharge. A helical spring may be used in place of the nitrogen spring. However, a helical spring is not capable of providing a constant force throughout its entire range of travel and of necessity would be longer in length to achieve the required force output and travel distance. Discharge fluid from accumulator chamber (31) is routed through accumulator port holes (35) within the ram piston (34) to the ram piston rod end chamber (39) and continues through the connecting fluid passage (28) to drive piston cap end chamber (38).

Hydraulic fluid sealed between the drive piston rod end (37) and ram piston cap end chamber (40) develops sufficient pressure to multiply the force output of the ram piston to perform useful work. The cap end surface area of ram piston (34) is sufficiently greater than the surface area of drive piston rod end (37) to cause a significant intensification in fluid pressure. Ram piston (34) will continue to extend until it reaches end of stroke, or external stop or encounters sufficient external load resistance to stall before reaching the end of stroke.

The piston advance sensor (32) detects the extend position of ram piston (34) and piston retract sensor (33) detects the retract position of ram piston (34) and home sensor (42) detects the retract position (home position) of drive piston (17). The drive piston (17) will continue to extend until the command position distance has been achieved. Linear distances traveled by drive piston (17) have a linear relationship to motor resolver (5) count values retained in the servo drive motion controller and program.

After the drive piston (17) reaches end of stroke extend distance, the servo motor reverses rotation to return the drive and ram pistons to their home positions. The servo drive motion controller will issue a fault signal if the home position sensor (42) does not detect the return of drive piston (17) within a specified number of resolver counts. The drive piston is programmed to offset (move) in the direction of retract motion a specified number of resolver counts immediately after detection by home position sensor (42). Off setting the drive piston (17) position in the opposite direction would cause the ram piston to prematurely extend and may not be desirable for many applications.

On the return motion of drive piston (17) hydraulic fluid on drive piston cap end chamber (38) is routed back through fluid passage (28) to ram piston rod end chamber (39) causing the ram piston to retract, recharge the accumulator fill the drive piston rod end chamber (41). Fluid from the drive piston cap end chamber (38) passes through check valve (18) to keep the drive piston rod end chamber (41) filled with fluid.

The linear actuator of the instant invention is a high force output linear actuator requiring no external hydraulic or pneumatic power sources, control valves or plumbing to operate. The output force of the linear actuator of the instant invention is significantly greater than that of a linear ball screw type mechanism of the same size and specifications. The compact and self contained construction of the linear actuator of the instant invention eliminates the need for external hydraulic and pneumatic power sources, external valves and plumbing as required by conventional hydraulic and pneumatic actuators and systems. Applications for the high force linear actuator of the instant invention are, without limitation thereto, hole punch, hole pierce, lifting, mechanical forming presses, clinching, forming, staking, shearing and embossing ferrous and non-ferrous materials.

The linear actuator of the instant invention in its preferred embodiment combines hydraulic intensification principles, electromechanical servo drive, linear ball screw, and hydraulic accumulator and control valves to achieve high output force. Hydraulic fluid required to operate the unit is contained within the body of the actuator. Moving components within the actuator body are submerged in hydraulic fluid thereby increasing the life expectancy of said components and including the linear ball screw and nut assembly. The actuator embodiment shown in FIG. 1 incorporates a rapid advance stroke of 2.50 inches, advance power stroke of 0.50 inches and rapid return stroke of 3.00 inches to reduce the overall cycle time. The power stroke automatically engages at any point along the advance stroke travel when the ram encounters a sufficient load resistance. In this embodiment, the actuator will transition into the power stroke when the external resistance exceeds 250 pounds of force. The automatic power stroke feature reduces the overall cycle time and eliminates the necessity for establishing and maintaining a fixed distance relationship between the ram and work surface.

The actuator embodiment shown in FIG. 1 will move a 250 pound load in both the rapid advance and rapid return directions. The rapid advance and return force values can be modified in either direction through alterations to the internal control valves. A hydraulic accumulator is integrated into the body of ram piston rod to provide make up fluid to the drive piston head chamber during advance motion. The accumulator also reclaims the same amount of fluid as the drive piston returns to home position. The accumulator also performs as an energy storage device to dissipate and absorb shock forces developed during, for example, hole punch and shearing operations. Shock attenuation reduces noise levels, extends the life of actuator and the equipment directly attached to the actuator.

During rapid advance the drive piston and ram piston advance the same linear distances and at the same rates of travel. During advance power stroke motion the linear distance traveled by the ram is proportionally less than that of the drive piston. Differential travel distances and rates of travel between the drive and ram pistons during rapid advance, rapid return and power stroke are possible. This is accomplished by varying the surface area ratios between the drive piston head, drive piston rod, ram piston head and ram piston rod diameters. The ram rate of travel, travel distance, positional accuracy, and acceleration and deceleration rates is dependant upon the drive piston rate of travel, travel distance, positional accuracy, and acceleration and deceleration rates.

The servo motor of the preferred embodiment provides the source of power, rate of travel, travel distance, positional accuracy and acceleration and deceleration rates imparted to the drive piston. The hydraulic fluid serves as a power transmission and coupling medium which in turn imparts motion to the ram piston and multiplies the ram output force in relationship to the drive piston input force.

The instant invention can also incorporate means for converting the linear motion of the ram to rotary motion such as by positioning a gear rack on or integral with the ram, the gear rack meshed with a geared wheel or by using a connecting rod attached at one end thereof to the ram and at the other end thereof to the crank pin of a crank. And, of course, the member to be controlled can be hydraulic flipper for imparting rotary motion (instead of a hydraulic ram). Such hydraulic flipper can be integral with the actuator or separate therefrom with suitable lines for fluid communication of the hydraulic fluid.

The instant invention may be embodied in other forms or carried out in other ways without departing from the spirit or scope of the invention. Modifications and variations thereof still falling within the spirit or the scope of the invention will be readily apparent to those of skill in the art.

1. An improved electrohydraulic actuator, comprising a piston secured to a member to be controlled and capable of moving in a cylinder under drive from a hydraulic fluid, a pump for pressurizing hydraulic fluid, an electric motor for driving the pump and a hydraulic accumulator for containment of variable volumes of hydraulic fluid, wherein the improvement comprises: the pump comprising a pump piston positioned in and slidably sealed in a first pump cylinder for pressurizing hydraulic fluid in the first pump cylinder; a piston rod extending through and slidably sealed to the pump piston; a second pump cylinder for receiving the piston rod slidably sealed in the second pump cylinder for pressurizing hydraulic fluid in the second pump cylinder, the diameter of the first pump cylinder being greater than the diameter of the second pump cylinder, so that when the hydraulic fluid pressure increases above a set pressure in the first pump cylinder, then the piston rod enters the second pump cylinder to pressurize the hydraulic fluid in the second pump cylinder to a pressure above the set pressure.

2. The improved electrohydraulic actuator of claim 1, wherein the piston rod is connected to the electric motor by way of a ball screw assembly.

3. The improved electrohydraulic actuator of claim 1, wherein if the pump piston reaches the end of the first pump cylinder without the hydraulic fluid pressure increasing above the set pressure in the first pump cylinder, then the piston rod enters the second pump cylinder to pressurize the hydraulic fluid in the second pump cylinder.

4. The improved electrohydraulic actuator of claim 2, wherein if the pump piston reaches the end of the first pump cylinder without the hydraulic fluid pressure increasing above the set pressure in the first pump cylinder, then the piston rod enters the second pump cylinder to pressurize the hydraulic fluid in the second pump cylinder.

5. An improved method for electrohydraulic actuation, comprising the steps of pressurizing hydraulic fluid with an electric pump, moving a member to be controlled under drive from the pressurized hydraulic fluid, wherein the improvement comprises the step of: intensifying the pressure of the hydraulic fluid when the pressure of the hydraulic fluid increases to a set point.
